(19) United States
(12) Patent Application Publication
(10) Pub. No.: US 2022/0003896 A1
(43) Pub. Date: Jan. 6, 2022

(54) OPTICAL FILTER

(71) Applicant: AGC Inc., Tokyo (JP)

(72) Inventors: Takashi NAGATA, Shizuoka (JP); Takahiro SAKAGAMI, Shizuoka (JP)

(73) Assignee: AGC Inc., Tokyo (JP)

(21) Appl. No.: 17/448,415

(22) Filed: Sep. 22, 2021

Related U.S. Application Data
(63) Continuation of application No. PCT/JP2020/011524, filed on Mar. 16, 2020.

(51) Int. Cl. G02B 1/115; G02B 5/28

(52) U.S. Cl. CPC G02B 1/115; G02B 5/281

(57) ABSTRACT

An optical filter includes a glass substrate in which an average-optical-transmittance in a specific-visible-region defined as a wavelength range of 430 nm to 650 nm is 80% or more and an average-optical-transmittance in a specific-infrared-region defined as a wavelength range of 900 nm to 1,000 nm is 25% to 85%, a first-optical-multilayer film in which an average-optical-transmittance in the specific-visible-region is 80% or more and an average-optical-transmittance in the specific-infrared-region is in a range of 45% to 65%, the first-optical-multilayer film having, between the specific-visible region and the specific-infrared-region, a first-blocking-band that blocks light, and a second-optical-multilayer-film in which an average-optical-transmittance in the specific-visible-region is 80% or more and an average-optical-transmittance in the specific-infrared-region is in a range of 45% to 65%, the second-optical-multilayer film having, on a side of wavelengths longer than those in the specific-infrared-region, a second-blocking-band that blocks light.

### CROSS-REFERENCE TO RELATED APPLICATIONS

This application is a continuation of International Application PCT/JP2020/011524, filed on Mar. 16, 2020 and designated the U.S., which is based on and claims priority to Japanese Patent Application No. 2019-063526 filed on Mar. 28, 2019, with the Japan Patent Office. The entire contents of these applications are incorporated herein by reference.

### BACKGROUND OF THE INVENTION

### 1. Field of the Invention

The present disclosure relates to an optical filter that allows light having wavelengths in the infrared region to pass through.

### 2. Description of the Related Art

A solid-state imaging device such as a charge coupled device (CCD) image sensor, a complementary metal oxide semiconductor (CMOS) image sensor, and the like has a strong sensitivity to infrared light as compared to the visual sensitivity characteristic of humans. Therefore, for example, in digital cameras, digital video, and the like, spectral correction is performed with use of an optical filter such as an infrared cut filter.

In an image-capturing device such as a monitoring camera that continuously performs image capturing day and night, the incidence of light having wavelengths in the visible region enables image capturing to be performed during the daytime hours. During the nighttime hours, it may be necessary to take in light having wavelengths in the infrared region due to the dark conditions. Therefore, it may be necessary to perform spectral correction by using an optical filter that allows both light in the visible region and light in the infrared region to pass through.

An optical filter that allows both light in the visible region and light in the infrared region to pass through can be configured by properly designing an optical multilayer film that is arranged on a substrate. That is, the aforementioned optical characteristics can be exhibited by forming an optical multilayer film having a repeating high refractive index layer and low refractive index layer structure.

For example, PTD1 and PTD2 each describe an optical filter capable of passing light in the visible region and light in the infrared region by a repeating high refractive index layer and low refractive index layer structure.

In conventional optical filters, in a case where there is an increased number of layers to be included in an optical multilayer film, the optical filter-to-optical filter variation in optical characteristics tends to increase when mass produced. This is because when the number of layers included in the optical multilayer film is increased, fluctuations in the thicknesses of the respective layers impact the optical characteristics to an extent that cannot be dismissed. In particular, in the infrared region, when the number of layers included in the optical multilayer film is increased, variations might occur in the optical characteristics such as optical transmittance to an extent that cannot be dismissed.

The present disclosure is made in view of such a background and it is an object of the present disclosure to provide an optical filter capable of effectively suppressing variations in the optical characteristics even when there is an increased number of layers included in the optical multilayer film.

### CITATION LIST

### Patent Literature

[PTD 1] Japanese Laid-open Patent Publication No. 2006-10764
[PTD 2] Japanese Laid-open Patent Publication No. 2016-109809

### SUMMARY OF THE INVENTION

In the present disclosure, an optical filter is provided that includes a glass substrate in which an average optical transmittance in a specific visible region defined as a wavelength range of 430 nm to 650 nm is 80% or more and an average optical transmittance in a specific infrared region defined as a wavelength range of 900 nm to 1,000 nm is 25% to 85%,

a first optical multilayer film in which an average optical transmittance in the specific visible region is 80% or more and an average optical transmittance in the specific infrared region is in a range of 45% to 65%, the first optical multilayer film having, between the specific visible region and the specific infrared region, a first blocking band that blocks light, and

a second optical multilayer film in which an average optical transmittance in the specific visible region is 80% or more and an average optical transmittance in the specific infrared region is in a range of 45% to 65%, the second optical multilayer film having, on a side of wavelengths longer than those in the specific infrared region, a second blocking band that blocks light.

According to at least one embodiment of the present disclosure, an optical filter capable of effectively suppressing variations in the optical characteristics even when there is an increased number of layers included in the optical multilayer film can be provided.

### BRIEF DESCRIPTION OF THE DRAWINGS

FIG. 1 is a diagram schematically illustrating an example of optical transmittance characteristics of a glass substrate included in an optical filter according to an embodiment of the present disclosure;

FIG. 2 is a diagram schematically illustrating an example of optical transmittance characteristics of a first optical multilayer film that is included in the optical filter according to the embodiment of the present disclosure;

FIG. 3 is a diagram schematically illustrating an example of optical transmittance characteristics of a second optical multilayer film included in the optical filter according to the embodiment of the present disclosure;

FIG. 4 is a diagram schematically illustrating an example of optical transmittance characteristics obtained in the optical filter according to the embodiment of the present disclosure;

FIG. 5 is a diagram schematically illustrating a cross-section of the optical filter according to the embodiment of the present disclosure;

FIG. 6 is a diagram schematically illustrating a cross-section of an optical filter according to another embodiment of the present disclosure;

FIG. 7 is a graph illustrating optical characteristics of Glass A that is used in the embodiment of the present disclosure;

FIG. 8 is a graph illustrating optical characteristics obtained by simulation calculation regarding the first optical multilayer film that is used in the embodiment of the present disclosure;

FIG. 9 is a graph illustrating optical characteristics obtained by simulation calculation regarding the second optical multilayer film that is used in the embodiment of the present disclosure;

FIG. 10 is a graph illustrating optical characteristics obtained by simulation calculation regarding the optical filter according to the embodiment of the present disclosure;

FIG. 11 is a graph illustrating optical characteristics of Glass B that is used in the other embodiment of the present disclosure;

FIG. 12 is a graph illustrating optical characteristics obtained by simulation calculation regarding the optical filter according to the other embodiment of the present disclosure;

FIG. 13 is a graph illustrating optical characteristics of Glass C that is used in a comparative example; and

FIG. 14 is a graph illustrating optical characteristics obtained by simulation calculation regarding an optical filter according to a comparative example.

### DESCRIPTION OF THE PREFERRED EMBODIMENTS

Hereinafter, an embodiment of the present disclosure is described with reference to the drawings.

The optical transmittance of a glass substrate and an optical filter in the embodiment of the present disclosure, unless otherwise noted, is a value taking into account a reflection of the interface of the substrate and air. Also, the optical transmittance of an optical multilayer film represents the optical transmittance in a case where the optical multilayer film is provided on super white glass, and this optical transmittance is a value taking into account the reflection of the rear surface side of the white glass where the optical multilayer film is not provided.

In one aspect of the present disclosure, there is provided an optical filter that includes:

a glass substrate in which an average optical transmittance in a specific visible region defined as a wavelength range of 430 nm to 650 nm is 80% or more and an average optical transmittance in a specific infrared region defined as a wavelength range of 900 nm to 1,000 nm is 25% to 85%;

a first optical multilayer film in which an average optical transmittance in the specific visible region is 80% or more and an average optical transmittance in the specific infrared region is in a range of 45% to 65%, the first optical multilayer film having, between the specific visible region and the specific infrared region, a first blocking band that blocks light; and

a second optical multilayer film in which an average optical transmittance in the specific visible region is 80% or more and an average optical transmittance in the specific infrared region is in a range of 45% to 65%, the second optical multilayer film having, on a side of wavelengths longer than those in the specific infrared region, a second blocking band that blocks light.

In the present disclosure, a numerical value range expressed using “to” includes the upper limit value and the lower limit value. In the present disclosure, “specific visible region” refers to a wavelength range of 430 nm to 650 nm, whereas “specific infrared region” refers to a wavelength range of 900 nm to 1,000 nm. Also, as described further below, the wavelength range of 1,100 nm to 1,200 nm is specifically referred to as “second specific infrared region”.

The optical filter according to the embodiment of the present disclosure includes a glass substrate. The glass substrate is unique in that the average optical transmittance in the specific visible region is 80% or more and the average optical transmittance in the specific infrared region is 25% to 85%.

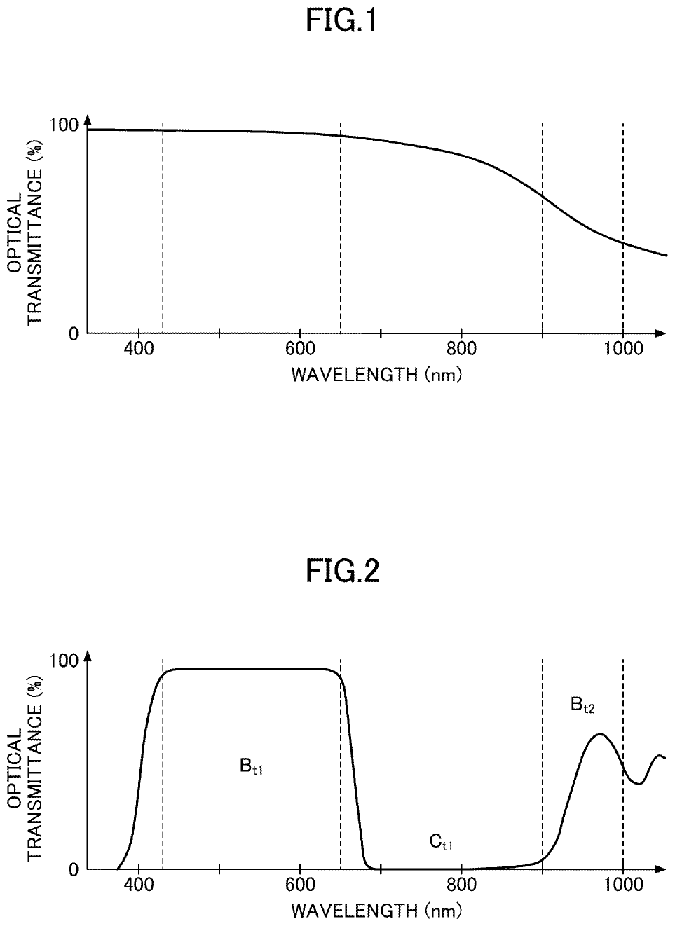

FIG. 1 schematically illustrates an example of optical transmittance characteristics of a glass substrate to be used in an optical filter according to the embodiment of the present disclosure.

As illustrated in FIG. 1, this glass substrate has a high transmittance in the specific visible region, with the average optical transmittance in the specific visible region being 80% or more.

This glass substrate is also unique in that in the specific infrared region, the optical transmittance drops as compared to the specific visible region, with the average optical transmittance in the specific visible region being in a range of 25% to 85%.

Also, the optical filter according to the embodiment of the present disclosure includes a first optical multilayer film.

The first optical multilayer film has an average optical transmittance that is 80% or more in the specific visible region, and has an average optical transmittance that is in a range of 45% to 65% in the specific infrared region. Also, the first optical multilayer film is unique in that that first optical multilayer film has, between the specific visible region and the specific infrared region, a first blocking band that blocks light.

FIG. 2 schematically illustrates an example of optical transmittance characteristics of a first optical multilayer film that is to be used in the optical filter according to the embodiment of the present disclosure.

As illustrated in FIG. 2, the first optical multilayer film has a first optical transmission band Bₜ₁ in the specific visible region and has a second optical transmission band Bₜ₂ in the specific infrared region. The first optical multilayer film also has a first blocking band Cₜ₁ between the first optical transmission band Bₜ₁ and the second optical transmission band Bₜ₂.

In the first optical multilayer film, the first optical transmission band Bₜ₁ has a high transmittance, with the average optical transmittance of the specific visible region being 80% or more, for example.

The second optical transmission band Bₜ₂ has a transmittance that is mid-range or higher, with the average optical transmittance of the specific infrared region being in a range of 45% to 65%, for example.

In contrast to this, the first blocking band Cₜ₁ has a low transmittance, with the average optical transmittance in the wavelength range of 780 nm to 830 nm being 3% or less, for example.

In the first optical multilayer film, the optical characteristics at wavelengths higher than the specific infrared region is not particularly limited. As such, the curved line illustrated in FIG. 2 is simply one example.

The optical filter according to the embodiment of the present disclosure also has a second optical multilayer film.

The second optical multilayer film has an average optical transmittance that is 80% or more in the specific visible region, and has an average optical transmittance that is in a range of 45% to 65% in the specific infrared region. Also, the second optical multilayer film is unique in that the second optical multilayer film has, on a side of wavelengths longer than those in the specific infrared region, a second blocking band that blocks light.

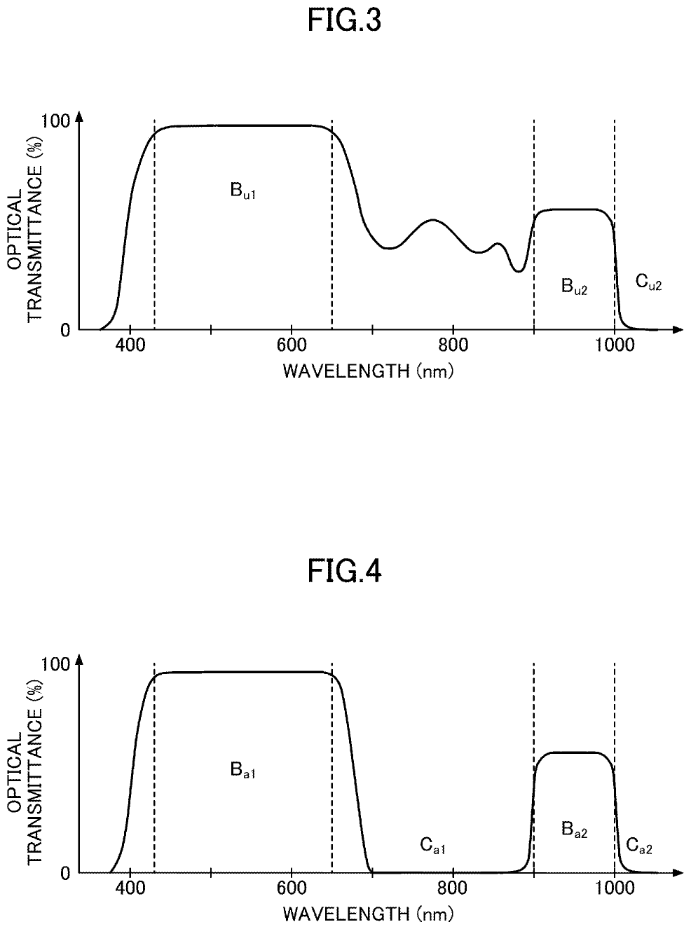

FIG. 3 schematically illustrates an example of optical transmittance characteristics of the second optical multilayer film to be used in the optical filter according to the embodiment of the present disclosure.

As illustrated in FIG. 3, the second optical multilayer film has a first optical transmission band Bᵤ₁ in the specific visible region and has a second optical transmission band Bᵤ₂ in the specific infrared region. The second optical multilayer film also has, on the side of wavelengths longer than those in the second optical transmission band Bᵤ₂, a second blocking band Cᵤ₂.

In the second optical multilayer film, the first optical transmission band Bᵤ₁ has a high transmittance. For example, the average optical transmittance of the specific visible region is 80% or more.

The second optical transmission band Bᵤ₂ has a mid-range transmittance. For example, the average optical transmittance of the specific infrared region is in a range of 45% to 65%.

The second blocking band Cᵤ₂ has a low transmittance, with the average optical transmittance being 5% or less in a range of 1,050 nm to 1,200 nm.

In the second optical multilayer film, the optical characteristic between the specific visible region and the specific infrared region is not particularly limited. As such, the curved line illustrated in FIG. 3 is simply one example.

Since the optical filter according to the embodiment of the present disclosure has the glass substrate, the first optical multilayer film, and the second optical multilayer film each having the previously-mentioned respective features, the optical characteristics of the optical filter, as a combination of the optical characteristics of the respective members, is as illustrated in FIG. 4.

FIG. 4 schematically illustrates an example of optical transmittance characteristics obtained in the optical filter according to the embodiment of the present disclosure.

As illustrated in FIG. 4, the optical transmittance curved line of the optical filter according to the embodiment of the present disclosure includes a first optical transmission band Bₐ₁ in the specific visible region and a second optical transmission band Bₐ₂ in the specific infrared region.

The optical transmittance curved line of the optical filter according to the embodiment of the present disclosure also includes a first blocking band Cₐ₁ between the first optical transmission band Bₐ₁ and the second optical transmission band Bₐ₂ and a second blocking band Cₐₜ on a side of wavelengths longer than those in the second optical transmission band Bₐ₂.

The first optical transmission band Bₐ₁ has a high transmittance, with the average optical transmittance in the specific visible region being 80% or more, for example. Also, the second optical transmission band Bₐ₂ has a mid-range transmittance, with the average optical transmittance in the specific infrared region being in a range of 40% to 90%, for example.

The first blocking band Cₐ₁ has a low transmittance, with the average optical transmittance being 5% or less in a wavelength range of 700 nm to 850 nm, for example. Also, the second blocking band Cₐ₂ has a low transmittance, with the average optical transmittance being 5% or less in a wavelength range of 1,050 nm to 1,200 nm.

In the example illustrated in FIG. 4, the first optical transmission band Bₐ₁ has an allowable wavelength range of 430 nm to 650 nm, whereas the second optical transmission band Bₐ₂ has an allowable wavelength range of 900 nm to 1,000 nm.

However, this is simply one example. As long as the average optical transmittance is 80% or more in the specific visible region, the first optical transmission band Bₐ₁ may exist in a narrower region. Likewise, as long as the average optical transmittance is in a range of 40% to 60% in the specific infrared region, the second optical transmission band Bₐ₂ may exist in a narrower region.

Also, in the example illustrated in FIG. 4 the first blocking band Cₐ₁ has an allowable wavelength range of 700 nm to 850 nm, whereas the second blocking band Cₐ₂ has an allowable wavelength region of 1,000 nm or more.

However, this is simply one example. As long as the average optical transmittance is 5% or less in wavelength range of 700 nm to 850 nm, the first blocking band Cₐ₁ may exist in a narrower region.

The same holds true for the second blocking band Cₐ₂ as well.

Here, as is evident from FIG. 4, the optical filter according to the embodiment of the present disclosure is capable of allowing light to pass through both the specific visible region and the specific infrared region. Therefore, the optical filter according to the embodiment of the present disclosure can be used, for example, in an image-capturing device that continuously performs image capturing day and night, and in the like.

Also, the glass substrate in the optical filter according to the embodiment of the present disclosure is unique in that the average optical transmittance is 25% to 85% in the specific infrared region.

In a conventional optical filter, there is a tendency for variation in optical characteristics to increase as the number of layers included in the optical multilayer film increases. This is because, as the number of layers included in the optical multilayer film increases, even a slight variation in the thicknesses of the respective layers can impact the optical characteristics to an extent that cannot be dismissed. Particularly, when the number of layers included in the optical multilayer film is increased, the variation in the optical characteristics of the optical transmittance and the like in the specific infrared region is too great to be dismissed.

However, in a case where a glass substrate having the aforementioned features is used as a portion of the optical filter, a portion of the light in the specific infrared region is absorbed. Therefore, the impact on characteristic variation that can occur in the second optical transmission band Bₜ₂ in the first optical multilayer film and in the second optical transmission band Bᵤ₂ in the second optical multilayer film can be effectively reduced or eliminated owing to the light absorption characteristics of the glass substrate.

Accordingly, in the optical filter according to the embodiment of the present disclosure, variation in the optical characteristic in the second optical transmission band Bₐ₂ exhibited by the combination of the glass substrate, the first optical multilayer film, and the second optical multilayer film can be effectively suppressed even when there are many layers included in the first optical multilayer film or the second optical multilayer film or both.

In the optical filter according to the embodiment of the present disclosure, due to the light absorption characteristic of the glass substrate, the optical transmittance of the optical filter in the specific infrared region decreases somewhat. This notwithstanding, the optical transmittance of the second optical transmission band Bₐ₂ of the optical filter according to the embodiment of the present disclosure can be maintained in a range of 40% to 60%, for example.

Furthermore, in the optical filter according to the embodiment of the present disclosure, the aforementioned features can also effectively suppress the problem of dependence on angle of light incidence that can arise in the second optical transmission band Bₐ₂.

That is, in a conventional optical filter, a suitable combination of optical multilayer films results in the exhibition of an optical transmission band in the specific infrared region. However, the optical characteristics of such optical multilayer films are problematic in that they change depending on the light angle of incidence.

In contrast to this, in the optical filter according to the embodiment of the present disclosure, the second optical transmission band Bₐ₂ in the specific infrared region decreases to a range of 40% to 60%, for example, owing to the absorption characteristics of the glass substrate. Also, such an absorption characteristic of the glass substrate is unique in that the dependence on angle of incidence is small.

Therefore, in the optical filter according to the embodiment of the present disclosure, the optical characteristic of the second optical transmission band Bₐ₂ is unlikely to be impacted by the angle of light incidence, and thus the problem of angular dependence can be reduced.

(Optical Filter According to the Embodiment of the Present Disclosure)

Next, the embodiment of the present disclosure is described in greater detail with reference to FIG. 5.

FIG. 5 schematically illustrates an example of a cross-section of an optical filter (hereinafter referred to as “first optical filter”) 100 according to the embodiment of the present disclosure.

As illustrated in FIG. 5, the first optical filter 100 includes a glass substrate 110, a first optical multilayer film 130, and a second optical multilayer film 160.

The glass substrate 110 has a first main surface 112 and a second main surface 114 opposite to each other. The first optical multilayer film 130 and the second optical multilayer film 160 are both disposed over the first main surface 112 of the glass substrate 110.

In the example illustrated in FIG. 1, the second optical multilayer film 160 is placed closer to the substrate than the first optical multilayer film 130 is. However, the placement order of the first optical multilayer film 130 and the second optical multilayer film 160 may be reversed.

The glass substrate 110 has an average optical transmittance that is 80% or more in the specific visible region. Also, the glass substrate 110 has an average optical transmittance in a range of 25% to 85% in the specific infrared region. The glass substrate 110 has optical transmittance characteristics such as those illustrated in FIG. 1 described above.

The first optical multilayer film 130 has an average optical transmittance that is 80% or more in the specific visible region. Also, the first optical multilayer film 130 has an average optical transmittance that is in a range of 45% to 65% in the specific infrared region, and the first blocking band has, between the specific visible region and the specific infrared region, the first blocking band that blocks light.

The first optical multilayer film 130 may have optical transmittance characteristics such as those illustrated in FIG. 2 described above, for example.

The first optical multilayer film 130 has a repeating “high refractive index layer” and “low refractive index layer” structure. The term “high refractive index layer” refers to a layer that has a refractive index of 2.0 or more at a wavelength of 500 nm, whereas the term “low refractive index layer” refers to a layer that has a refractive index of 1.6 or less at a wavelength of 500 nm.

In the example as illustrated in FIG. 5, the first optical multilayer film 130 has a first high refractive index layer 132-1, a first low refractive index layer 132-2, a second high refractive index layer 132-3, a second low refractive index layer 132-4, . . . , and an m-th low refractive index layer 132-m, for example. Here, m is an integer from 2 to 100, for example.

In contrast to this, the second optical multilayer film 160 has an average optical transmittance that is 80% in the specific visible region. The second optical multilayer film 160 also has an average optical transmittance in a range of 45% to 65% in the specific infrared region, and has, on a side of wavelengths longer than those in the specific infrared region, the second blocking band that blocks light.

The second optical multilayer film 160 may have optical transmittance characteristics such as those illustrated in FIG. 3 described above, for example.

The second optical multilayer film 160 also has a repeating “high refractive index layer” and “low refractive index layer” structure as does the first optical multilayer film 130.

In the example illustrated in FIG. 5, the second optical multilayer film 160 has a first high refractive index layer 162-1, a first low refractive index layer 162-2, a second high refractive index layer 162-3, a second low refractive index layer 162-4, . . . , and an n-th low refractive index layer 162-n, for example. Here, n is an integer from 2 to 130, for example.

However, as is described further below, the configurations of the second optical multilayer film 160, for example, the thicknesses of the respective layers are different from the first optical multilayer film 130.

In the first optical filter 100 that includes such a configuration, optical transmittance characteristics such as those illustrated in FIG. 4 described above can be obtained.

In the first optical filter 100, as described above, the impact on characteristic variation that can occur in the first optical multilayer film 130 and the second optical multilayer film 160 can be effectively reduced or eliminated owing to the light absorption characteristics of the glass substrate 110.

Accordingly, in the first optical filter 100, variation in the optical characteristic in the second optical transmission band Bₐ₂ can be effectively suppressed even when there are many layers included in the first optical multilayer film 130 or the second optical multilayer film 160 or both.

Also, in the first optical filter 100, dependence on angle of light incidence in the specific infrared region can be effectively suppressed.

(Regarding Each Constituent Member of the Optical Filter)

Next, each optical member to be used in the optical filter according to the embodiment of the present disclosure is described in greater detail.

In the description below, for the sake of clarity, the reference numbers illustrated in FIG. 5 are used for describing the respective members.

(Glass Substrate 110)

At long as the glass substrate 110 has the features described above, the glass substrate may have any composition.

The glass substrate 110 may be infrared-absorbing glass that contains an infrared-absorbing component.

The infrared-absorbing component may be iron or copper or both, for example. The amount of the infrared-absorbing component may be 0.05 cations or more. Examples of the glass substrate 110 include borosilicate glass containing copper, phosphate glass containing copper, and phosphate glass containing iron, but the glass substrate 110 is not limited to these examples.

The glass substrate 110, as previously described, has an average optical transmittance of 80% or more in the specific visible region. The average optical transmittance in the specific visible region is preferably 81% or more, and more preferably 82% or more.

Also, the glass substrate 110 has an average optical transmittance of 25% to 85% in the specific infrared region. The average optical transmittance in the specific infrared region is preferably in a range of 30% to 80% and more preferably in a range of 35% to 75%.

The thickness of the glass substrate 110 is not particularly limited. However, in a case where the first optical filter 100 is to be used in a compact device, the thickness of the glass substrate 110 is preferably in a range of 0.05 mm to 2 mm to ensure thinness of the first optical filter 100.

The glass substrate 110 may satisfy:

T_{glass}<Tₜ₁₊ₜ₂ Formula (1)

where T_{glass} (%) is the average optical transmittance in the specific infrared region. Here, Tₜ₁₊ₜ₂(%) is the average optical transmittance in the specific infrared region and is obtainable by taking the first optical multilayer film 130 and the second optical multilayer film 160 in combination.

In a case where Formula (1) is satisfied, the first optical filter 100 obtains an effect whereby optical transmittance variation associated with mass production can be reduced.

(First Optical Multilayer Film 130)

As long as the first optical multilayer film 130 has the previously-described features, the first optical multilayer film 130 may have any layer configuration.

The first optical multilayer film 130 may have a repeating high refractive index layer and low refractive index layer structure, as described above.

The number of times of repetition is not particularly limited but is, for example, in a range of 1 time to 50 times (that is, the number of layers is 2 to 100). The number of times of repetition is preferably 20 times or less or more preferably 15 times or less.

As described above, variation in the optical characteristics can be effectively suppressed even if the number of times of repetition in the first optical multilayer film 130 of the first optical filter 100 is increased to 20 times or more, for example. Therefore, the number of times of repetition can be effectively increased as compared to conventional technology, and thus optical design of a more precise optical filter can be achieved.

Examples of the high refractive index layer include titanium oxide, tantalum oxide, niobium oxide, and the like. Examples of the low refractive index layer include silicon oxide, magnesium fluoride, and the like. For example, the refractive index layer of titanium oxide at a wavelength of 500 nm is generally in a range of 2.3 to 2.8 depending on the crystalline phase, whereas the refractive index of silicon oxide is generally in a range of 1.4 to 1.5 depending on the crystalline phase.

In the first optical multilayer film 130, the optical transmittance characteristics as illustrated in FIG. 2 described above can be obtained by adjusting the thicknesses of the respective high refractive index layers and the respective low refractive index layers.

(Second Optical Multilayer Film 160)

As long as the second optical multilayer film 160 has the previously-described features, the first optical multilayer film 160 may have any layer configuration.

The second optical multilayer film 160 may have a repeating high refractive index layer and low refractive index layer structure, as described above.

The number of times of repetition is not particularly limited but is, for example, in a range of 1 time to 70 times (that is, the number of layers is 2 to 140). The number of times of repetition is preferably 50 times or less or more preferably 26 times or less.

As described above, in the first optical filter 100, variation in the optical characteristics can be effectively suppressed even if the number of times of repetition in the second optical multilayer film 160 is increased to 20 times or more. Therefore, the number of times of repetition can be effectively increased as compared to conventional technology.

Examples of the high refractive index layer include titanium oxide and the like, whereas examples of the low refractive index layer include silicon oxide and the like.

In the second optical multilayer film 160, the optical transmittance characteristics as illustrated in FIG. 3 described above can be obtained by adjusting the thicknesses of the respective high refractive index layers and the respective low refractive index layers.

(First Optical Filter 100)

The first optical filter 100 has optical transmittance characteristics as illustrated in FIG. 4, for example.

The first optical filter 100 may have an average optical transmittance of 80% or more in the specific visible region. The average optical transmittance in the specific visible region is preferably 85% or more and more preferably 90% or more.

The first optical filter 100 has the first optical transmission band Bₐ₁ in the specific visible region. The first optical transmission band Bₐ₁ may exist along the entire wavelength range of 430 nm to 650 nm.

The first optical filter 100 also has the second optical transmission band Bₐ₂ in the specific infrared region. The second optical transmission band Bₐ₂ may exist along the entirety of the wavelength range of 900 nm to 1,000 nm. Also, the central wavelength in the second optical transmission band Bₐ₂ may be in a range of 920 nm to 980 nm. Alternatively, the central wavelength in the second optical transmission band Bₐ₂ may be in a range of 930 nm to 960 nm.

Also, the first optical filter 100 may have an average optical transmittance of less than 3% in a wavelength range of 780 nm to 830 nm. Moreover, the first optical filter 100 may have an average optical transmittance of 2.5% or less in the second specific infrared region.

Here, in the first optical filter 100, the absorption contribution level P of the glass substrate 110 expressed as Formula (2) below may be 32% or more.

Absorption contribution level P (%)=(V₁/V₂)×100 Formula (2)

Here, V₁ is expressed as:

V₁=100(%)−T_{glass} (%) Formula (3)

And V₂ is expressed as:

V₂=100(%)−average optical transmittance (%) in specific infrared region of first optical filter 100 Formula (4)

Also, in the first optical filter 100, second absorption contribution level Q of glass substrate 110 represented by Formula (5) below may be 9% or more:

Second absorption contribution level Q (%)=(W₁/W₂)×100 Formula (5)

Here, W₁ is expressed as:

W₁=100(%)−average optical transmittance (%) in second specific infrared region of glass substrate 110 Formula (6)

Here, W₂ is expressed as:

W₂=100(%)−average optical transmittance (%) in second specific infrared region of first optical filter 100 Formula (7)

As described above, the “second specific infrared region” is represented by a wavelength range of 1,100 nm to 1,200 nm.

(Optical Filter According to Another Embodiment of the Present Disclosure)

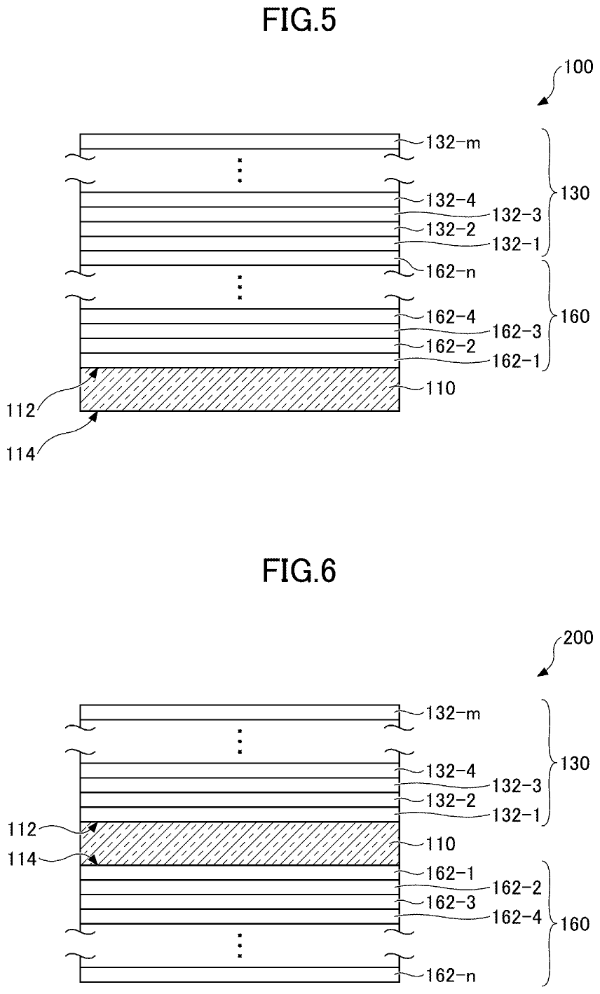

Next, an optical filter according to another embodiment of the present disclosure is described with reference to FIG. 6.

FIG. 6 schematically illustrates a cross-section of an optical filter (hereinafter, referred to as “second optical filter”) 200 according to the other embodiment of the present disclosure.

As illustrated in FIG. 6, the second optical filter 200 includes the glass substrate 110, the first optical multilayer film 130, and the second optical multilayer film 160.

However, the placement of the first and the second optical multilayer films in the second optical filter 200 is different from that in the previously-described first optical filter 100. That is, in the second optical filter 200, the first optical multilayer film 130 is placed on the side where the first main surface 112 of the glass substrate 110 is, whereas the second optical multilayer film 160 is placed on the side where the second main surface 114 of the glass substrate 110 is.

Even the second optical filter 200 having such a configuration can obtain the optical transmittance characteristics as illustrated in FIG. 4 as previously described.

Also, even in the second optical filter 200, an effect is substantially the same as the effect obtained with first optical filter 100, that is, an effect of effectively suppressing variation in optical characteristics in the second optical transmission band Bₐ₂ even if the number of layers included in the first optical multilayer film 130 or the second optical multilayer film 160 or both is increased, can be obtained.

Moreover, even in the second optical filter 200, dependence on angle of light incidence in the specific infrared region can be effectively suppressed.

In the above, the configuration according to the embodiments of the present disclosure is described using the first optical filter 100 and the second optical filter 200 as examples.

However, in the present disclosure, it is apparent to one skilled in the art that the optical filter can be obtained by other configurations.

For example, in the first optical filter 100 or the second optical filter 200, a third optical multilayer film having a third blocking band in a specific visible region can be provided. In such as case, an optical filter having an optical transmission band (for example, the second optical transmission band Bₐ₂) only in the specific infrared region and not having any optical transmission bands in the specific visible region can be obtained.

The first and second optical filters 100, 200 having such functions can be applied to an image-capturing device or the like. Examples of the image-capturing device include a monitoring camera, a vehicle camera, a web camera, and the like.

### EMBODIMENT EXAMPLES

Next, the embodiment examples of the present disclosure are described.

In the description below, the first example and the second example are embodiment examples whereas the third example is a comparative example. Also, the simulation calculations were performed using optical thin-film design software (TF Calc developed by Software Spectra, Inc.) Also, there is an anti-reflective film (not illustrated) on the second main surface 114.

### First Example

An optical filter (hereinafter, referred to as “optical filter according to the first example”) such as that illustrated in FIG. 5, described above, was formed by combining the glass substrate, the first optical multilayer film, and the second optical multilayer film together.

Infrared absorbing glass having a “Glass A” composition in Table 1 indicated below was used in the glass substrate. The thickness of the glass substrate is 0.3 mm.

TABLE 1

| | | Glass A | Glass B |
|---|---|---|---|
| Cation | P | 65.0 | 45.2 |
| Percentages | B | 0.0 | 0.0 |
| | Al | 16.9 | 9.5 |
| | Li | 2.8 | 25.2 |
| | Na | 2.8 | 0.0 |
| | K | 1.8 | 0.0 |
| | Mg | 2.3 | 3.4 |
| | Ca | 0.0 | 4.7 |
| | Sr | 0.0 | 5.8 |
| | Ba | 1.1 | 6.0 |
| | Zn | 4.0 | 0.0 |
| | Cu | 0.0 | 0.2 |
| | Fe | 3.4 | 0.0 |
| Cation Total | | 100.0 | 100.0 |
| Anion | O | 100.0 | 85.8 |
| Percentages | F | 0.0 | 14.2 |

| | | |
|---|---|---|
| Anion Total | 100.0 | 100.0 |

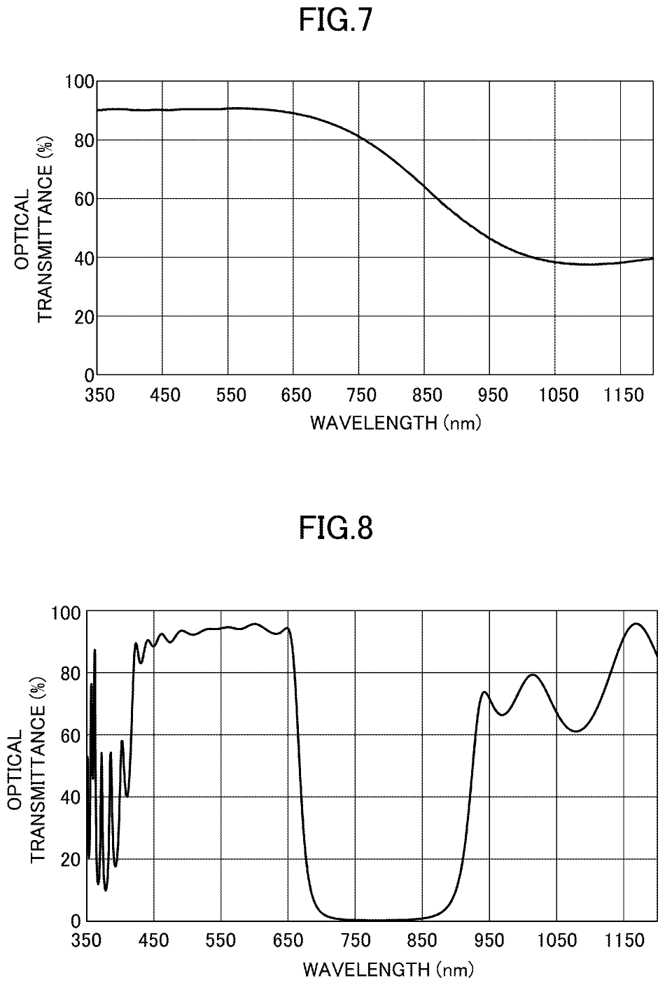

In FIG. 7, the optical characteristics of the Glass A are illustrated.

The average optical transmittance T_{glass} in the specific infrared region of the Glass A is 46.9%. The average optical transmittance in the second specific infrared region of the Glass A is 38.3%.

In Table 2 and Table 3 below, the respective configurations of the first optical multilayer film and the second optical multilayer film that are layered over the glass substrate are illustrated.

TABLE 2

| Member | Layer No. | Material | Thickness (nm) |
|---|---|---|---|
| First Optical | 1 | TiO₂ | 107.45 |
| Multilayer Film | 2 | SiO₂ | 144.52 |
| | 3 | TiO₂ | 82.01 |
| | 4 | SiO₂ | 135.34 |
| | 5 | TiO₂ | 80.54 |
| | 6 | SiO₂ | 132.54 |
| | 7 | TiO₂ | 80.75 |
| | 8 | SiO₂ | 132.08 |
| | 9 | TiO₂ | 81.57 |
| | 10 | SiO₂ | 132.2 |
| | 11 | TiO₂ | 82.59 |
| | 12 | SiO₂ | 134.54 |
| | 13 | TiO₂ | 93.22 |
| | 14 | SiO₂ | 79.79 |
| | 15 | TiO₂ | 16.38 |
| | 16 | SiO₂ | 26.41 |
| | 17 | TiO₂ | 78.71 |
| | 18 | SiO₂ | 39.45 |
| | 19 | TiO₂ | 29.67 |
| | 20 | SiO₂ | 24.92 |
| | 21 | TiO₂ | 60.63 |
| | 22 | SiO₂ | 85.93 |

TABLE 3

| | Layer | | Thickness |
|---|---|---|---|
| Member | No. | Material | (nm) |
| Second | 1 | TiO₂ | 26.75 |
| Optical | 2 | SiO₂ | 30.83 |
| Multilayer | 3 | TiO₂ | 36.26 |
| Film | 4 | SiO₂ | 209.68 |
| | 5 | TiO₂ | 30.27 |
| | 6 | SiO₂ | 28.18 |
| | 7 | TiO₂ | 133.29 |
| | 8 | SiO₂ | 185.43 |
| | 9 | TiO₂ | 115.76 |
| | 10 | SiO₂ | 191.02 |
| | 11 | TiO₂ | 121.52 |
| | 12 | SiO₂ | 52.35 |
| | 13 | TiO₂ | 23.17 |
| | 14 | SiO₂ | 72.35 |
| | 15 | TiO₂ | 24.57 |
| | 16 | SiO₂ | 48.74 |
| | 17 | TiO₂ | 118.94 |
| | 18 | SiO₂ | 169.17 |
| | 19 | TiO₂ | 102.3 |
| | 20 | SiO₂ | 43.04 |
| | 21 | TiO₂ | 16.72 |
| | 22 | SiO₂ | 51.99 |
| | 23 | TiO₂ | 13.04 |
| | 24 | SiO₂ | 12.33 |
| | 25 | TiO₂ | 119.43 |
| | 26 | SiO₂ | 42.42 |
| Second | 27 | TiO₂ | 23.93 |
| Optical | 28 | SiO₂ | 65.62 |
| Multilayer | 29 | TiO₂ | 30.34 |
| Film | 30 | SiO₂ | 33.07 |
| | 31 | TiO₂ | 127.48 |
| | 32 | SiO₂ | 174.76 |
| | 33 | TiO₂ | 127.22 |
| | 34 | SiO₂ | 27.26 |
| | 35 | SiO₂ | 33.5 |
| | 36 | SiO₂ | 71.28 |
| | 37 | TiO₂ | 11.82 |
| | 38 | SiO₂ | 79.26 |
| | 39 | TiO₂ | 44.84 |
| | 40 | SiO₂ | 24.19 |
| | 41 | TiO₂ | 41.11 |
| | 42 | SiO₂ | 42.96 |
| | 43 | TiO₂ | 119.62 |
| | 44 | SiO₂ | 64.57 |
| | 45 | TiO₂ | 19.67 |
| | 46 | SiO₂ | 36.83 |
| | 47 | TiO₂ | 233.38 |
| | 48 | SiO₂ | 16.54 |
| | 49 | TiO₂ | 135 |
| | 50 | SiO₂ | 19.26 |
| | 51 | TiO₂ | 130.28 |
| | 52 | SiO₂ | 26.36 |

The first optical multilayer film has a repeating high refractive index layer and low refractive index layer structure and the number of layers is 22. Also, the second optical multilayer film has a repeating high refractive index layer and low refractive index layer structure and the number of layers is 52. In both the first optical multilayer film and the second optical multilayer film, the high refractive index layers are TiO₂ and the low refractive index layers are SiO₂.

The first optical multilayer film is layered on the second optical multilayer film. That is, the optical filter according to the first example is formed by layering in order of the glass substrate, the second optical multilayer film, and the first optical multilayer film.

Here, in Table 2 and Table 3, the lower the layer number is, the closer the layer is to the glass substrate. Therefore, in the first example, on one main surface of the glass substrate, the second optical multilayer film is formed, and then the first optical multilayer film is also formed. The second optical multilayer film has a total of 52 layers, with the first layer thereof having a thickness of 26.75 nm, whereas the first optical multilayer film has a total of 22 layers, with the first layer thereof having a thickness of 107.45 nm.

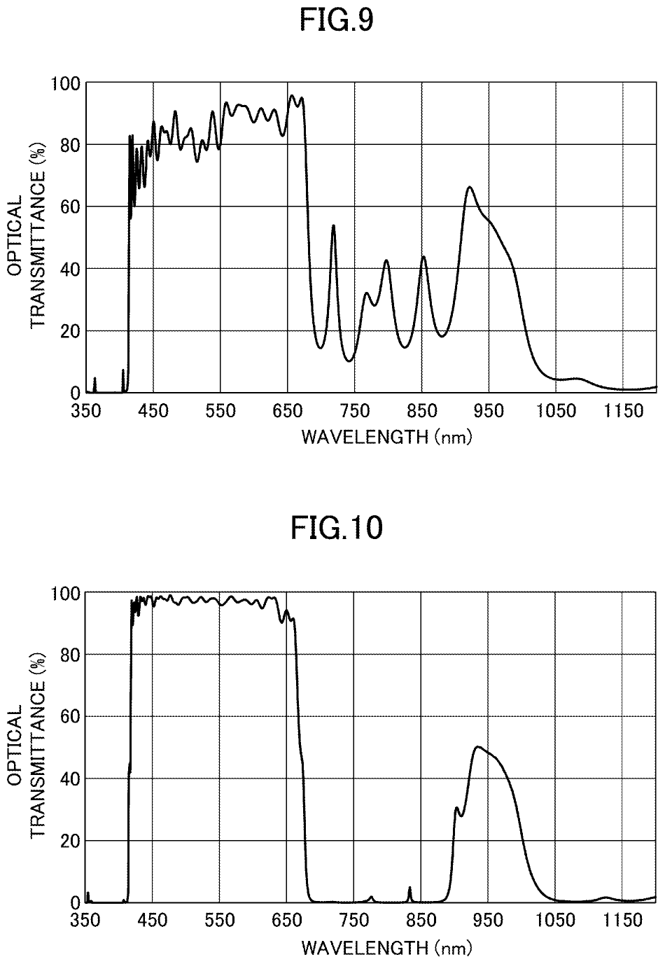

FIG. 8 illustrates optical characteristics obtained by simulation calculation regarding the first optical multilayer film. FIG. 9 illustrates optical characteristics obtained by simulation calculation regarding the second optical multilayer film.

The average optical transmittance Tₜ₁₊ₜ₂ (%) in the specific infrared region obtained by the combination of the first optical multilayer film and the second optical multilayer film was 79.4%.

FIG. 10 illustrates optical characteristics obtained by simulation calculation regarding the optical filter according to the first example.

The average optical transmittance in the specific visible region of the optical filter according to the first example was 96.9%. Also, the average optical transmittance in the specific infrared region was 40.1% and the average optical transmittance in the second specific region infrared region was 1.0%.

The absorption contribution level P of the glass substrate was obtained based on the aforementioned Formula (2). The result was:

Absorption contribution level P (%)=(V₁/V₂)×100{(100−46.9)/(100−40.1)}×100=88.6%.

Also, the second absorption contribution level Q of the glass substrate was obtained based on the aforementioned Formula (5). The result was:

Second absorption contribution level Q (%)=(W₁/W₂)×100{(100−38.3)/(100−1.0)}×100=62.3%.

### Second Example

An optical filter (hereinafter, referred to as “optical filter according to the second example” was formed by the same method as that in the first example.

However, in this second example, an infrared absorption glass having the composition of “Glass B” in aforementioned Table 1 was used as the glass substrate.

The other conditions were the same as those in the first example.

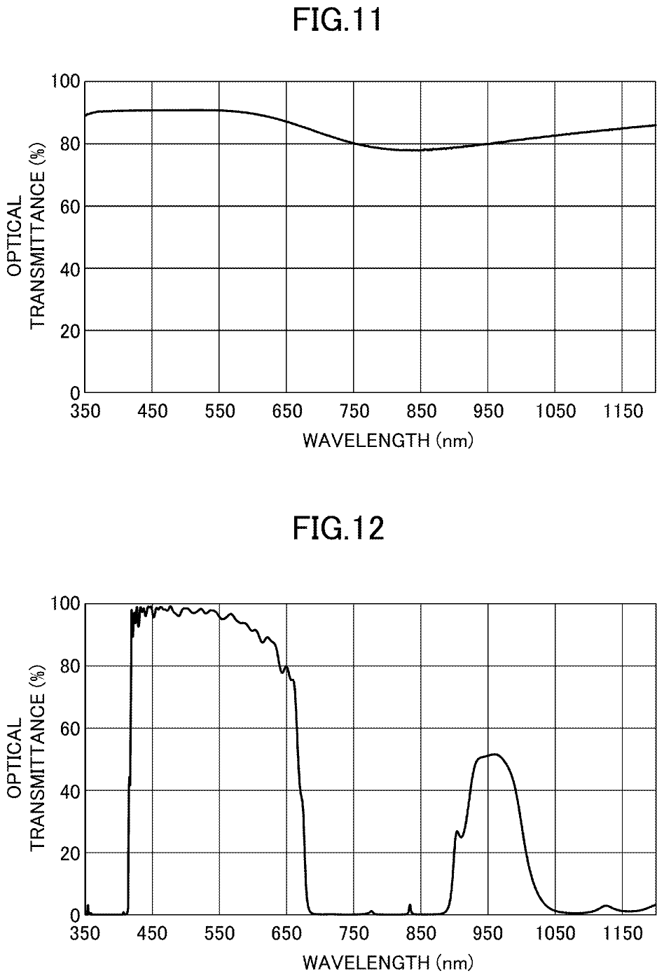

FIG. 11 illustrates optical characteristics of Glass B.

The average optical transmittance T_{glass} in the specific infrared region of Glass B was 80.0%. Also, the average optical transmittance in the second specific infrared region of Glass B was 84.2%.

FIG. 12 illustrates optical characteristics obtained by simulation calculation regarding the optical filter according to the second example.

The average optical transmittance in the specific visible region of the optical filter according to the second example was 94.3. Also, the average optical transmittance in the specific infrared region was 42.5%, and the average optical transmittance in the second specific infrared region was 1.8%.

The absorption level contribution P and the second absorption contribution level Q of the glass substrate were obtained based on aforementioned Formula (2) and Formula (5), respectively. As the results, the absorption contribution level P was 34.8% and the second absorption contribution level Q was 15.4%.

### Third Example

An optical filter (hereinafter, referred to as “optical filter according to the third example” was formed by the same method as that in the first example.

However, in the third example, commercially-available glass (D263 made by Schott) was used as the glass substrate. This glass substrate is hereinafter referred to as “Glass C”.

The other conditions were the same as those in the first example.

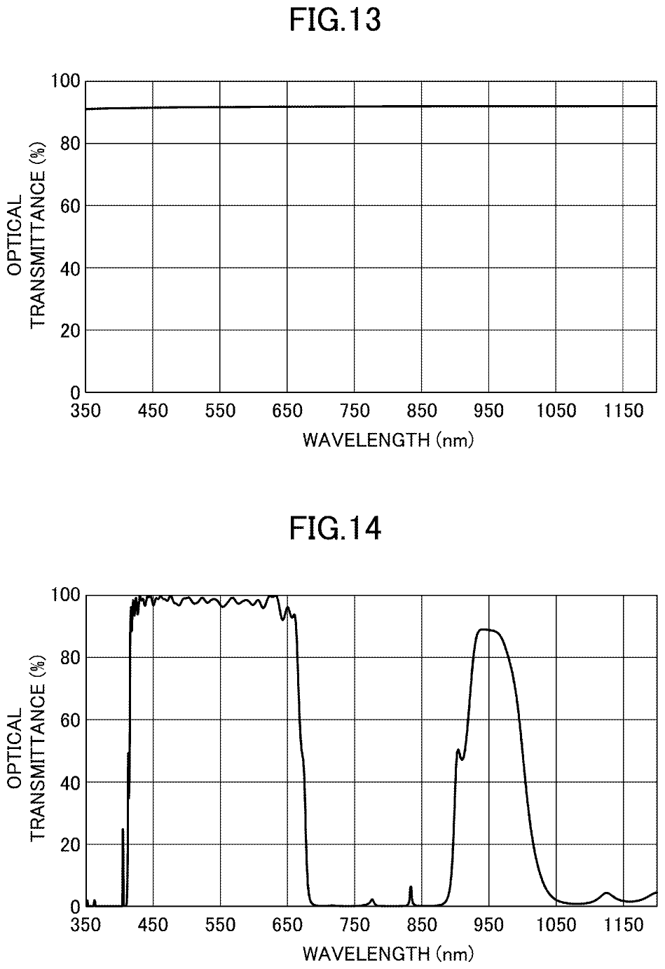

FIG. 13 illustrates optical characteristics of Glass C.

The average optical transmittance T_{glass} in the specific infrared region of Glass C was 92.0%. Also, the average optical transmittance in the second specific infrared region of Glass C was 92.0%.

FIG. 14 illustrates optical characteristics obtained by simulation calculation regarding the optical filter according to the third example.

The average optical transmittance in the specific visible region of the optical filter according to the third example was 98.0%. Also, the average optical transmittance in the specific infrared region was 74.3% whereas the average optical transmittance in the second specific infrared region was 2.6%.

The absorption contribution level P and the second absorption contribution level Q of the glass substrate were obtained based on aforementioned (2) Formula and (5) Formula, respectively. As the results, the absorption contribution level P was 31.3% whereas the second absorption contribution level Q was 8.2%.

Table 4 below illustrates the main optical characteristics of the respective optical filters according to the first example, the second example, and the third example.

TABLE 4

| | Ex 1 | Ex 2 | Ex 3 |
|---|---|---|---|
| Average optical transmittance T_{glass} (%) | 46.9 | 80.0 | 92.0 |
| in specific infrared region of glass substrate | | | |
| Average optical transmittance (%) in second | 38.3 | 84.2 | 92.0 |
| specific infrared region of glass substrate | | | |
| Average optical transmittance Tₜ₁₊ₜ₂ (%) of | 79.4 | 79.4 | 79.4 |
| specific infrared region obtained by | | | |
| combination of first optical multilayer film | | | |
| and second optical multilayer film | | | |
| Average optical transmittance (%) of specific | 92.8 | 92.8 | 92.8 |
| visible region by first optical multilayer film | | | |
| Average optical transmittance (%) of specific | 84.8 | 84.8 | 84.8 |
| visible region by second optical multilayer | | | |
| film | | | |
| Average optical transmittance Tₜ₁ (%) of | 57.9 | 57.9 | 57.9 |
| speciific infrared region by first optical | | | |
| multilayer film | | | |
| Average optical transmittance Tₜ₂ (%) of | 50.4 | 50.4 | 50.4 |
| specific infrared region by second optical | | | |
| multilayer film | | | |
| Absorption contribution level P (%) of glass | 88.6 | 34.8 | 31.3 |
| substrate | | | |
| Second absorption contribution level Q (%) | 62.3 | 15.4 | 8.2 |
| of glass substrate | | | |
| Average optical transmittance (%) in specific | 96.9 | 94.3 | 98.0 |
| visible region of optical filter | | | |
| Average optical transmittance (%) in specific | 40.1 | 42.5 | 74.3 |
| infrared region of optical filter | | | |
| Average optical transmittance (%) in second | 1.0 | 1.8 | 2.6 |
| specific infrared region of optical filter | | | |

(Evaluation)

In the respective optical filters according to the first example, the second example, and the third example, variation that can occur in optical transmittance characteristics was evaluated using the Monte Carlo simulation under certain assumptions.

As preconditions, when the first optical multilayer film having the configuration illustrated in aforementioned Table 2 and the second optical multilayer film having the configuration illustrated in aforementioned Table 3 (total layer number of 74 layers) are layered over the glass substrate, it is assumed that a variation of 3σ=2.6% in thickness occurs in the respective layers. Moreover, it is also assumed that a variation of ±12 μm in the thickness of the glass substrate occurs.

The optical filter was formed one-hundred (100) times by simulation under the aforementioned preconditions. The extent of the variation in the average optical transmittance in the specific infrared region was evaluated based on the optical transmittance characteristics of the 100 optical filters that were obtained.

The results are illustrated below in Table 5.

TABLE 5

| | Ex 1 | Ex 2 | Ex 3 |
|---|---|---|---|
| Standard Devtation σ | 1.499 | 1.713 | 4.002 |

As can be seen from Table 5, in a case of the optical filter according to the third example, the standard deviation σ of the average optical transmittance in the specific infrared region was 4.002. In contrast to this, in the case of the optical filter according to the first example and the optical filter according to the second example, the standard deviation σ was under 2.

From this, it is evident that variation in the optical characteristics in the specific infrared region in the optical filters according to the first example and the second example can be effectively suppressed.

What is claimed is:

1. An optical filter comprising:
a glass substrate in which an average optical transmittance in a specific visible region defined as a wavelength range of 430 nm to 650 nm is 80% or more and an average optical transmittance in a specific infrared region defined as a wavelength range of 900 nm to 1,000 nm is 25% to 85%;
a first optical multilayer film in which an average optical transmittance in the specific visible region is 80% or more and an average optical transmittance in the specific infrared region is in a range of 45% to 65%, the first optical multilayer film having, between the specific visible region and the specific infrared region, a first blocking band that blocks light; and
a second optical multilayer film in which an average optical transmittance in the specific visible region is 80% or more and an average optical transmittance in the specific infrared region is in a range of 45% to 65%, the second optical multilayer film having, on a side of wavelengths longer than those in the specific infrared region, a second blocking band that blocks light.

2. The optical filter according to claim 1, wherein the average optical transmittance in the specific infrared region of the glass substrate is lower than an average optical transmittance in the specific infrared region obtained by a combination of the first optical multilayer film and the second optical multilayer film.

3. The optical filter according to claim 1, wherein an absorption contribution level P of the glass substrate expressed as Formula (I) below is 32% or more:
the absorption contribution level P (%)=(V₁/V₂)×100 Formula (I)
where V₁ is expressed as:
V₁=100(%)−the average optical transmittance (%) in the specific infrared region of the glass substrate Formula (II)
and where V₂ is expressed as:
V₂=100(%)−an average optical transmittance (%) in the specific infrared region of the optical filter. Formula (III)

4. The optical filter according to claim 1, wherein the optical filter has an average optical transmittance of 2.5% or less in a second specific infrared region defined as a wavelength range of 1,100 nm to 1,200 nm, and a second absorption contribution level Q of the glass substrate expressed as Formula (IV) below is 9% or more:
the second absorption contribution level Q (%)=(W₁/W₂)×100 Formula (IV)
where W₁ is expressed as:
W₁=100(%)−an average optical transmittance (%) in the second specific infrared region of the glass substrate Formula (V)
and where W₂ is expressed as:
W₂=100(%)−an average optical transmittance (%) in the second infrared region of the optical filter. Formula (VI)

5. The optical filter according to claim 1, wherein the glass substrate contains iron or copper or both.

6. The optical filter according to claim 1, wherein the glass substrate has a first main surface and a second main surface opposite to each other, and the first optical multilayer film and the second optical multilayer film are both provided on a side where the first main surface is.

7. The optical filter according to claim 1, wherein the glass substrate has a first main surface and a second main surface opposite to each other, and the first optical multilayer film is provided on a side where the first main surface is and the second optical multilayer film is provided on a side where the second main surface is.

8. The optical filter according to claim 1, wherein an average optical transmittance of the optical filter in the specific visible region is 80% or more.

9. The optical filter according to claim 1, further comprising a third optical multilayer film that blocks light in the specific visible region.
